(19) United States
(12) Patent Application Publication
(10) Pub. No.: US 2023/0001970 A1
(43) Pub. Date: Jan. 5, 2023

(54) Hand Truck Assembly And Method Of Use

(71) Applicants: Omar Marin, Winnetka, CA (US); Anna Cruz, Winnetka, CA (US)

(72) Inventors: Omar Marin, Winnetka, CA (US); Anna Cruz, Winnetka, CA (US)

(21) Appl. No.: 17/363,476

(22) Filed: Jun. 30, 2021

(51) Int. Cl. B62B 1/12; B62B 1/26

(52) U.S. Cl. CPC B62B 1/12; B62B 1/264

(57) ABSTRACT

A hand truck assembly for lifting and moving heavy loads includes a plate, which is engaged to and which extends from a lower end of a rod. The plate is positionable on a surface beneath a load with the rod extending upwardly. A user can grasp and pull the rod, proximate to an upper end of the rod. A rearward frame is engaged to and extends from the rod proximate to the lower end so that the rearward frame is opposingly positioned on the rod relative to the plate. An axle is rotationally engaged to the rearward frame and is perpendicular to the rod. A pair of wheels is engaged singly to opposed ends of the axle. A lower limit of the pair of wheels is coplanar with the plate. The load is lifted from the surface by pulling on the rod to pivot the plate around the axle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hand truck assemblies and more particularly pertains to a new hand truck assembly for lifting and moving heavy loads. The present invention discloses a hand truck assembly having an elongated rod with a pair of wheels positioned rearwardly from the rod relative to a plate from which the rod extends.

### (2) Description of Related Art Including Information Disclosed Under 37 CFR 1.97 and 1.98

The prior art relates to hand truck assemblies. Prior art hand truck assemblies generally comprise a pair of wheels from which a handle and plate extend, with the handle and the plate generally being oriented at 90°. The prior art lacks a hand truck assembly having an elongated rod with a pair of wheels positioned rearwardly from the rod relative to a plate from which the rod extends.

### BRIEF SUMMARY OF THE INVENTION

An embodiment of the disclosure meets the needs presented above by generally comprising a plate, which is engaged to and which extends from a lower end of a rod. The plate is configured to be positioned on a surface beneath a load so that the rod extends upwardly from the surface. A user is positioned to grasp and to pull the rod, proximate to an upper end of the rod. A rearward frame is engaged to and extends from the rod proximate to the lower end so that the rearward frame is opposingly positioned on the rod relative to the plate. An axle is rotationally engaged to the rearward frame so that the axle is perpendicular to the rod. A pair of wheels is engaged singly to opposed ends of the axle so that a lower limit of the pair of wheels is coplanar with the plate. The load is lifted from the surface by pulling on the rod to pivot the plate around the axle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a hand truck assembly according to an embodiment of the disclosure.

FIG. 2 is a rear view of an embodiment of the disclosure.

FIG. 3 is a side view of an embodiment of the disclosure.

FIG. 4 is a side view of an embodiment of the disclosure.

FIG. 5 is a top view of an embodiment of the disclosure.

FIG. 6 is an in-use view of an embodiment of the disclosure.

FIG. 7 is an in-use view of an embodiment of the disclosure.

FIG. 8 is an in-use view of an embodiment of the disclosure.

FIG. 9 is a flow diagram for a method utilizing an embodiment of the disclosure.

### DETAILED DESCRIPTION OF THE INVENTION

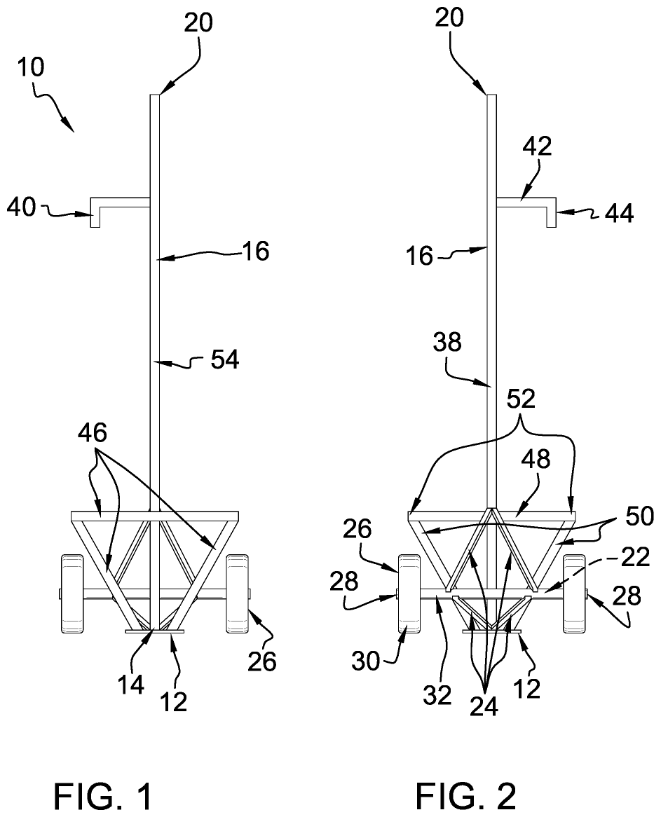

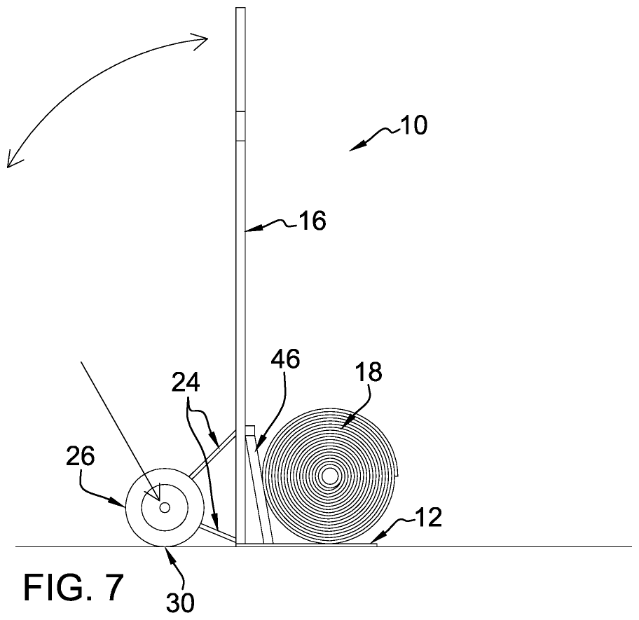

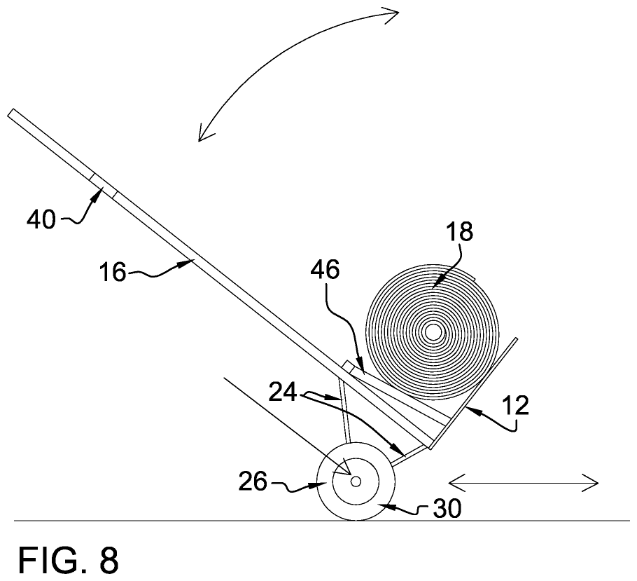

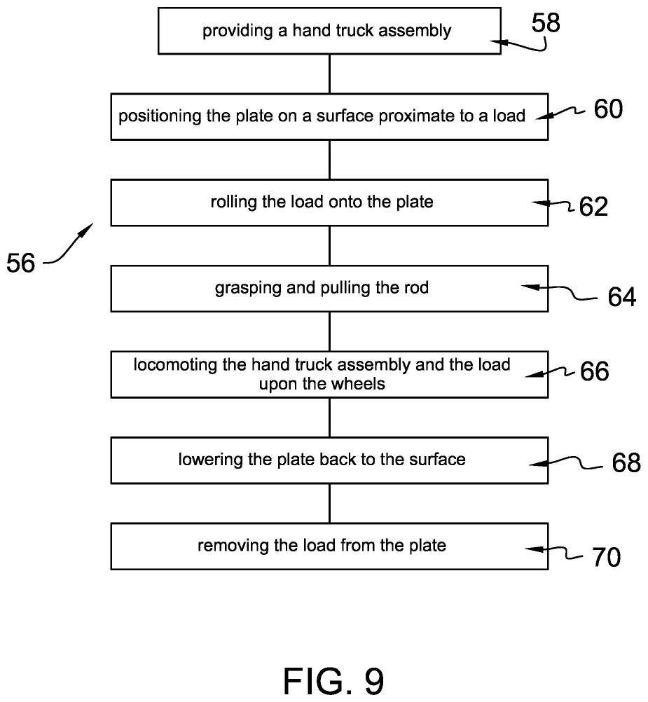

With reference now to the drawings, and in particular to FIGS. 1 through 9 thereof, a new hand truck assembly embodying the principles and concepts of an embodiment of the disclosure and generally designated by the reference numeral 10 will be described.

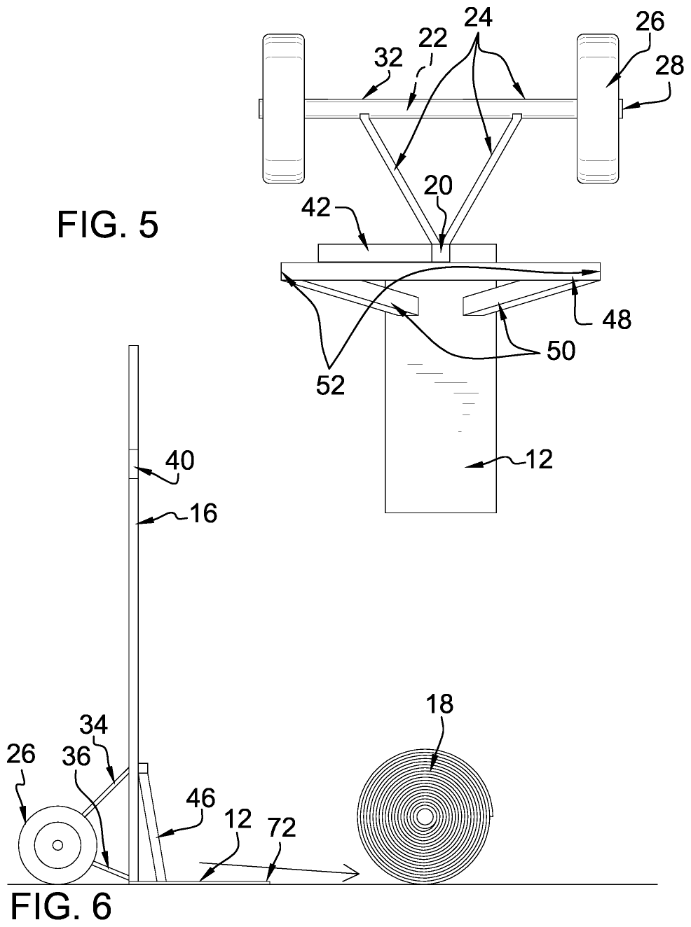

As best illustrated in FIGS. 1 through 9, the hand truck assembly 10 generally comprises a plate 12, which is engaged to and which extends from a lower end 14 of a rod 16. The plate 12 is configured to be positioned on a surface beneath a load 18 so that the rod 16 extends upwardly from the surface. A user is positioned to grasp and to pull the rod 16, proximate to an upper end 20 of the rod 16. The plate 12 may be substantially perpendicular to the rod 16, although the present invention anticipates the plate 12 being transverse to the rod 16. The plate 12 may be substantially rectangularly shaped, as shown in FIG. 5, or alternatively shaped. For example, a leading edge 72 of the plate 12 distal from the rod 16 may be arcuate to facilitate positioning of the plate 12 between the surface and the load 18.

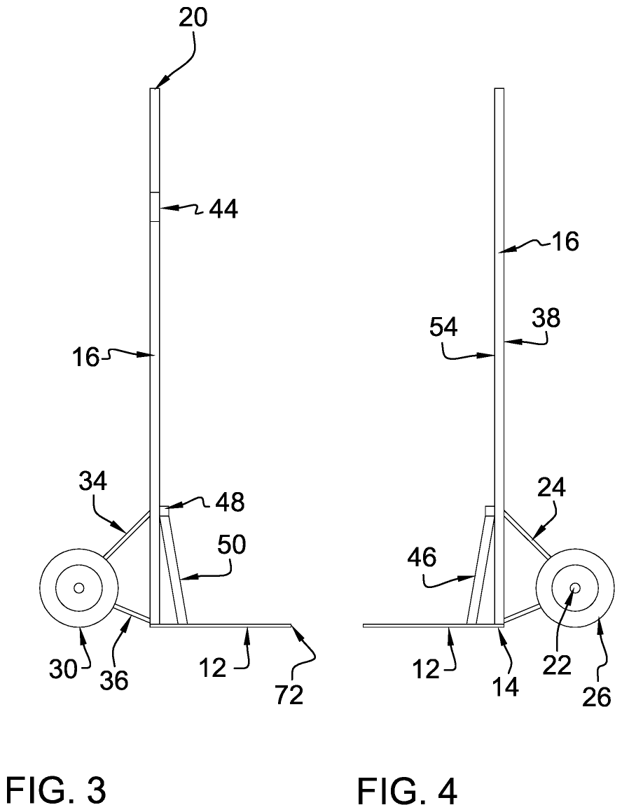

A rearward frame 24 is engaged to and extends from the rod 16 proximate to the lower end 14 so that the rearward frame 24 is opposingly positioned on the rod 16 relative to the plate 12, as shown in FIGS. 3 and 4. An axle 22 is rotationally engaged to the rearward frame 24 so that the axle 22 is perpendicular to the rod 16, as shown in FIG. 2. A pair of wheels 26 is engaged singly to opposed ends 28 of the axle 22 so that a lower limit 30 of the pair of wheels 26 is coplanar with the plate 12. The wheels 26 comprise metal and thus are rigid to support a heavy load 18. The wheels 26 may comprise steel. The load 18 is lifted from the surface by pulling on the rod 16 to pivot the plate 12 around the axle 22.

The present invention is anticipated to be beneficial in lifting and moving heavy loads 18, such as rolls of roofing material. The rod 16 is of sufficient length to provide leverage for lifting heavy loads 18 from the surface, for example 1.25 to 1.75 meters in length.

The rearward frame 24 comprises a tube 32, a pair of upper bars 34, and a pair of lower bars 36. The axle 22 is positioned in the tube 32 so that the tube 32 is configured to allow positioning of a foot of the user. The user is positioned to lean away from the rod 16, providing leverage to the user in pivoting the plate 12 around the axle 22.

Each of the upper bars 34 is engaged to and extends transversely between the rod 16 and the tube 32. The upper bars 34 are positioned on the rod 16 above the lower end 14 so that the upper bars 34 extend downwardly to the tube 32. Each of the lower bars 36 is engaged to and extends transversely between the lower end 14 of the rod 16 and the tube 32 so that the rearward frame 24 is substantially diamond shaped when viewed from a rear face 38 of the rod 16, as shown in FIG. 2.

A handle 40 may be engaged to the rod 16 proximate to the upper end 20 of the rod 16. The handle 40 and the rod 16 are configured to be grasped in first and second hands of the user. The user is positioned to pull on the handle 40 and the rod 16 to pivot the plate 12 around the axle 22, while also potentially positioning a foot on the tube 32 and leaning away from the rod 16 for additional leverage. The handle 40 also is helpful in turning the hand truck assembly 10 with the load 18 positioned on the plate 12.

The handle 40 comprises a first segment 42 and a second segment 44. The first segment 42 extends laterally and substantially perpendicularly from the rod 16. The second segment 44 extends substantially perpendicularly from the first segment 42 distal from the rod 16 and toward the plate 12. Other configurations of the handle 40 are anticipated by the present invention, such as, but not limited to, one or more hand grips, bars extending bilaterally from the rod 16, and the like.

A forward frame 46 is engaged to and extends transversely between the plate 12 and the rod 16. The forward frame 46 is positioned to brace the plate 12 and the rod 16. The forward frame 46 is configured to stabilize the load 18 upon the plate 12.

The forward frame 46 may comprise an upper member 48 and a pair of side members 50. The upper member 48 is engaged to the rod 16 above the lower end 14 and extends bilaterally from the rod 16. Each side member 50 is engaged to and extends between a respective opposing end 52 of the upper member 48 and the plate 12. The forward frame 46 is substantially inverted trapezoid shaped when viewed from a front face 54 of the rod 16, as shown in FIG. 1. The present invention anticipates other configurations of the forward frame 46, for example, solid or meshed plates, additional elements extending between the side members 50, and the like.

In use, the hand truck assembly 10 enables a method 56 of lifting and transporting a load 18. The method 56 comprises a first step 58 of providing a hand truck assembly 10 according to the specification above. A second step 60 of the method 56 is positioning the plate 12 on a surface proximate to a load 18 so that the rod 16 extends upwardly from the surface. A third step 62 of the method 56 entails rolling, or otherwise maneuvering, the load 18 onto the plate 12. A fourth step 64 of the method 56 is grasping and pulling the rod 16, proximate to an upper end 20 of the rod 16, to pivot the plate 12 around the axle 22 so that the load 18 is lifted from the surface. A fifth step 66 of the method 56 is locomoting the hand truck assembly 10 and the load 18 upon the wheels 26 to a desired location. A sixth step 68 of the method 56 is lowering the plate 12 back to the surface. A seventh step 70 of the method 56 is removing the load 18 from the plate 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hand truck assembly comprising:
a rod;
a plate engaged to and extending from a lower end of the rod, wherein the plate is configured for positioning on a surface beneath a load, such that the rod extends upwardly from the surface, positioning a user for grasping and pulling the rod, proximate to an upper end of the rod;
a rearward frame engaged to and extending from the rod proximate to the lower end, such that the rearward frame is opposingly positioned on the rod relative to the plate;
an axle rotationally engaged to the rearward frame, such that axle is perpendicular to the rod; and
a pair of wheels engaged singly to opposed ends of the axle, such that a lower limit of the pair of wheels is coplanar with the plate, such that the load is lifted from the surface by pulling on the rod to pivot of the plate around the axle.

2. The hand truck assembly of claim 1, wherein the plate is substantially perpendicular to the rod.

3. The hand truck assembly of claim 1, wherein the plate is substantially rectangularly shaped.

4. The hand truck assembly of claim 1, further including a handle engaged to the rod proximate to the upper end of the rod, wherein the handle and the rod are configured for grasping in first and second hands of the user, positioning the user for pulling on the handle and the rod for pivoting the plate around the axle.

5. The hand truck assembly of claim 4, wherein the handle comprises a first segment and a second segment, the first segment extending laterally and substantially perpendicularly from the rod, the second segment extending substantially perpendicularly from the first segment distal from the rod and toward the plate.

6. The hand truck assembly of claim 1, wherein the rearward frame comprises:
a tube, the axle being positioned in the tube, wherein the tube is configured for positioning of a foot of the user, such that the user is positioned for leaning away from the rod, providing leverage to the user for pivoting the plate around the axle;
a pair of upper bars, each of the upper bars being engaged to and extending transversely between the rod and the tube, the upper bars being positioned on the rod above the lower end, such that the upper bars extend downwardly to the tube; and
a pair of lower bars, each of the lower bars being engaged to and extending transversely between the lower end of the rod and the tube, such that the rearward frame is substantially diamond shaped when viewed from a rear face of the rod.

7. The hand truck assembly of claim 1, wherein the wheels comprise metal, such that the wheels are rigid.

8. The hand truck assembly of claim 7, wherein the wheels comprise steel.

9. The hand truck assembly of claim 1, further including a forward frame engaged to and extending transversely between the plate and the rod, such that the forward frame is positioned for bracing the plate and the rod, wherein the forward frame is configured for stabilizing the load upon the plate.

10. The hand truck assembly of claim 9, wherein the forward frame comprises:
an upper member engaged to the rod above the lower end and extending bilaterally from the rod; and
a pair of side members, each side member being engaged to and extending between a respective opposing end of the upper member and the plate, such that the forward frame is substantially inverted trapezoid shaped when viewed from a front face of the rod.

11. A method of lifting and transporting a load using hand truck assembly, the method comprising the steps of:
providing a hand truck assembly comprising:
a rod,
a plate engaged to and extending from a lower end of the rod,
a rearward frame engaged to and extending from the rod proximate to the lower end, such that the rearward frame is opposingly positioned on the rod relative to the plate,
an axle rotationally engaged to the rearward frame, such that axle is perpendicular to the rod, and
a pair of wheels engaged singly to opposed ends of the axle, such that a lower limit of the pair of wheels is coplanar with the plate;
positioning the plate on a surface proximate to a load, such that the rod extends upwardly from the surface;
rolling the load onto the plate;
grasping and pulling the rod, proximate to an upper end of the rod, for pivoting the plate around the axle, such that the load is lifted from the surface;
locomoting the hand truck assembly and the load upon the wheels to a desired location;
lowering the plate back to the surface; and
removing the load from the plate.

12. A hand truck assembly comprising:
a rod;
a plate engaged to and extending from a lower end of the rod, wherein the plate is configured for positioning on a surface beneath a load, such that the rod extends upwardly from the surface, positioning a user for grasping and pulling the rod, proximate to an upper end of the rod, the plate being substantially perpendicular to the rod, the plate being substantially rectangularly shaped;
a rearward frame engaged to and extending from the rod proximate to the lower end, such that the rearward frame is opposingly positioned on the rod relative to the plate, the rearward frame comprising:
a tube,
a pair of upper bars, each of the upper bars being engaged to and extending transversely between the rod and the tube, the upper bars being positioned on the rod above the lower end, such that the upper bars extend downwardly to the tube, and
a pair of lower bars, each of the lower bars being engaged to and extending transversely between the lower end of the rod and the tube, such that the rearward frame is substantially diamond shaped when viewed from a rear face of the rod;
an axle rotationally engaged to the rearward frame, such that axle is perpendicular to the rod, the axle being positioned in the tube, wherein the tube is configured for positioning of a foot of the user, such that the user is positioned for leaning away from the rod, providing leverage to the user for pivoting the plate around the axle;
a pair of wheels engaged singly to opposed ends of the axle, such that a lower limit of the pair of wheels is coplanar with the plate, such that the load is lifted from the surface by pulling on the rod to pivot of the plate around the axle, the wheels comprising metal, such that the wheels are rigid, the wheels comprising steel;
a handle engaged to the rod proximate to the upper end of the rod, wherein the handle and the rod are configured for grasping in first and second hands of the user, positioning the user for pulling on the handle and the rod for pivoting the plate around the axle, the handle comprising a first segment and a second segment, the first segment extending laterally and substantially perpendicularly from the rod, the second segment extending substantially perpendicularly from the first segment distal from the rod and toward the plate; and
a forward frame engaged to and extending transversely between the plate and the rod, such that the forward frame is positioned for bracing the plate and the rod, wherein the forward frame is configured for stabilizing the load upon the plate, the forward frame comprising:
an upper member engaged to the rod above the lower end and extending bilaterally from the rod, and
a pair of side members, each side member being engaged to and extending between a respective opposing end of the upper member and the plate, such that the forward frame is substantially inverted trapezoid shaped when viewed from a front face of the rod.
